(19) United States
(12) Patent Application Publication
(10) Pub. No.: US 2013/0073439 A1
(43) Pub. Date: Mar. 21, 2013

(54) METHODS AND SYSTEMS FOR PATENT VALUATION USING FINANCIAL RATIOS

(71) Applicants: Ashish Porwal, Rajasthan (IN); Rahul Jindal, North Sydney (AU)

(72) Inventors: Ashish Porwal, Rajasthan (IN); Rahul Jindal, North Sydney (AU)

(73) Assignee: CPA GLOBAL SUPPORT SERVICES INDIA PRIVATE LIMITED, Noida, UP (IN)

(21) Appl. No.: 13/698,495

(22) PCT Filed: May 18, 2011
(86) PCT No.: PCT/IN2011/000350

§ 371 Date: Nov. 16, 2012

(30) Foreign Application Priority Data
May 17, 2010 (IN) 1140/DEL/2010

(51) Int. Cl. G06Q 40/00

(52) U.S. Cl. 705/30

(57) ABSTRACT

A technique for valuation of intangible assets is provided. The technique includes determining a present value of all future earnings from an intangible asset based on a current earning and one or more financial ratios. The technique further includes determining a value of the intangible asset based on the present value of all future earnings.

### CROSS REFERENCE TO RELATED APPLICATIONS

This application claims the benefit of India Provisional Application No. 1140/DEL/2010, entitled “Methods and Systems for Patent Valuation using Financial Ratios”, filed on May 17, 2010, which is incorporated herein in its entirety by reference.

### BACKGROUND

The invention relates generally to valuation techniques for intangible assets and more particularly to valuation techniques for intangible assets using financial ratios.

In this increasingly competitive and global market scenario, innovation and product differentiation is the key to survival. Innovation is no more just a buzzword in a company's mission statement bat an irreplaceable part of their growth strategy. As with any other asset, innovation and other such intangible assets need to be protected. Innovation protection in the form of intellectual property (e.g., patent, trademark) has become progressively inure visible in the financial statements of companies. With a burst in activities of non-practicing entities, intellectual property litigations have become more common and so has the need for intellectual property valuation. Additionally, financial regulations such as the Sarbanes-Oxley act have given rise to a need for a standard approach to intellectual property valuation.

However, intellectual property valuation still is more an art than a science. Different valuation experts use different methodologies, rely on different parameters, and use different valuation models if at all to determine the value of an intangible asset such as an intellectual property. More often than not, the value is estimated based on transactions of similar patents or trademarks. In theory, intangible asset valuation using market comparable transactions is well established. However, it is rare to find a comparable transaction. For example, while estimating value of a patent it is difficult to find a comparable transaction of a patent belonging similar technology domain, having similar stakeholders, similar deal size, and above all, similar market scenario.

Typically, most intangible asset valuation models rely primarily on the income approach. However, there are quite a few challenges in developing and using any model based primarily on the income approach. These challenges may include, but are not limited to, inaccuracy in estimating the growth rate and risks associated with a intangible asset such as patented technology, subjectivity involved in royalty rate assessment due to the multitude of parameters that affect royalty rate, inability to differentiate between royalty rates for past and future infringements, subjectivity involved in assessing the out-licensing opportunities associated with the intangible asset, inadequate comparison with substitute asset such as substitute technologies, inadequate assessment of the industry's legal and economic scenario, and so forth. These challenges binder the standardization and acceptance of any valuation model for intangible asset.

It is therefore desirable to provide an efficient and standardized valuation technique for an intangible asset. It is further desirable that such valuation technique is objective, quantified, and parametric in nature.

### BRIEF DESCRIPTION

Briefly in accordance with one aspect of the technique, a method is provided for valuation of intangible assets. The method provides for determining a present value of all future earnings from an intangible asset based on a current earning and one or more financial ratios, and for determining a value of the intangible asset based on the present value of all future earnings. Processor-based systems and computer programs that afford such functionality may be provided by the present technique.

In accordance with another aspect the technique, a method is provided for valuation of intangible assets. The method provides for estimating or determining a current earning from an intangible asset and for determining a risk weighted growth multiple (RWGM) for the intangible, asset based on one or more financial ratios. The method also provides for determining a present value of all future earnings from the intangible asset based on the current earning and the risk weighted growth multiple, for estimating or determining a present royalty rate via a royalty assessment model, and for determining a value of the intangible asset based on the present value of all future earnings and the present royalty rate. Here again, processor-based systems and computer programs affording such functionality may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of a general-purpose computer system for valuation of intangible assets in accordance with aspects of the present technique;

FIG. 2 is a flowchart depicting an exemplary process for valuation of intangible assets in accordance with aspects of the present technique; and

FIG. 3 is a flowchart depicting the exemplary process of FIG. 2, in greater detail and in accordance with aspects of the present technique.

### DETAILED DESCRIPTION

The present techniques are generally directed to intangible asset valuation. Such techniques may be useful in valuation of a variety of legal and competitive intangible assets, such as patents, trademarks, service marks, vendor data, market data, human capitals, and so forth. Though the present discussion provides examples generally in context of legal intangible assets and more particularly in context of patents and patent portfolio, one of ordinary skill in the art will readily apprehend that the application of these techniques in other contexts, such as for competitive intangible assets, is well within the scope of the invention.

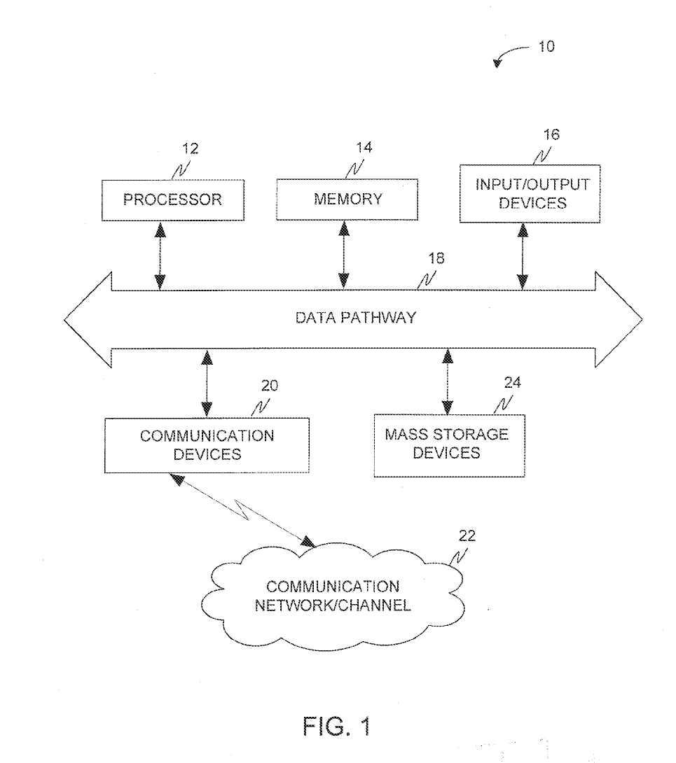

Referring now to FIG. 1, a schematic diagram of a general-purpose computer system 10 is illustrated in accordance with aspects of the present technique. The computer system 10 is configured to automatically perform valuation of intangible assets based on a variety of parameters. The computer system 10 generally includes a processor 12, a memory 14, and input/output devices 16 connected via a data pathway e.g., buses) 18.

The processor 12 accepts instructions and data from the memory 14 and performs various data processing functions of the system. These data processing functions may include, but are not limited to, acquiring market data and intangible asset data, determining a value of the intangible asset, determining royalty rates, and so forth. The processor 12 includes an arithmetic logic unit (ALU) that performs arithmetic and logical operations, and a control unit that extracts instructions from memory 14 and decodes and executes them, calling the ALU when necessary. The memory 14 stores a variety of data received by the system 10 and computed by the various data processing functions of the system 10. The data may include, for example, quantitative and qualitative data, such as financial data and ratios, intangible asset data, remaining economic life or a score of the intangible asset, market data, and so forth. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices 16, the data pathway 18, or in some other suitable manner.

The input/output devices 16 may include a keyboard and a mouse that enables a user to enter data and instructions into the computer system 10, a display device that enables the user to view the available information, and a printer that enables the user to print any data for his reference. The computer system it) may further include a communication device 20 such as a telephone, cable or wireless modem; or a network card such as an Ethernet adapter, local area network (LAN) adapter, integrated services digital network (ISDN) adapter, or Digital Subscriber Line (DSL) adapter; a USB port; IEEE 1394 port; and so forth, that enables the computer system 10 to access other computers and resources on a communication network 22. The communication network 22 may be a wired or a wireless communication network such as Internet, LAN, wide area network (WAN). The computer system 10 may also include a mass storage device 24 to allow the computer system 10 to retain large amounts of data permanently. The mass storage device may include all types of disk drives such as floppy disks, hard disks and optical disks, as well as tape drives that can read and write data onto a tape that could include digital audio tapes (DAT), digital linear tapes (DLT), or other magnetically ceded media. The above-described computer system 10 may take the form of a hand-held digital computer, personal digital assistant computer, notebook computer, personal computer, workstation, mini-computer, mainframe computer or supercomputer.

As will be appreciated by one skilled in the art, a variety of techniques may be employed to determine value of an intangible asset. For example, the exemplary computer system 10 may acquire market data and intangible asset data, determine a value of the intangible asset, and determine royalty rates by the techniques discussed herein. In particular, as will be appreciated by those of ordinary skill in the art, control logic and/or automated routines for performing the techniques and steps described herein may be implemented by the system 10, either by hardware, software, or combinations of hardware and software. For example, suitable code may be accessed and executed by the processor 12 to perform some or all of the techniques described herein. Similarly application specific integrated circuits (ASICs) configured to perform some or all of the techniques described herein may be included in the processor 12.

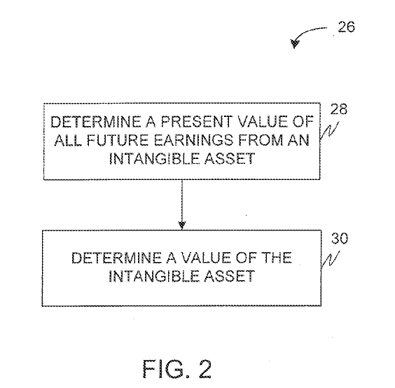

For example, referring now to FIG. 2, exemplary control logic 26 for valuation of intangible assets via a valuation system, such as system 10, is depicted via a flowchart in accordance with aspects of the present technique. As illustrated in the flowchart, the control logic 26 includes the steps of determining a present value of all future earnings from an intangible asset based on a current earning and one or more financial ratios at step 28, and determining a value of the intangible asset based on the present value of all future earnings at step 30. Additionally, in certain embodiments, the control logic 26 includes the step of determining past earnings from the intangible asset. In such embodiments, determining the value of the intangible asset at step 30 is based on the past earnings and the present value of all future earnings.

As will be appreciated by one skilled in the art, the current earning may include, but is not limited to, a projected or an actual earning in a year of analysis. For example, for a product based on a patented technology that is yet to be launched in the market a projected earning is estimated for a given year of analysis based on market sizing and product pricing. Similarly, for a product based on a patented technology that is already in the market an actual earning is determined or a projected earning is estimated for a given year of analysis. It should be noted that the year of analysis may be a previous year, a current year, or a future year.

The one or more financial ratios may include, but are not limited to, a price-earnings (PB) ratio, a price-book value (PB) ratio, an operating profit margin, a net profit margin, and so forth. It should be noted that, in certain embodiments, the PE ratio and PB ratio is per share. Further, it should be noted that, these financial ratios correspond to a company or an industry relevant to the intangible asset. In certain embodiments, the one or more financial ratios may be modified to reflect growth and risks associated with the intangible asset and/or to reflect a finite life of the intangible asset. As will be appreciated by those skilled in the art, typical valuation using financial ratios assumes that a company is a going concern and there will always be a terminal or salvage value for a company. However, an intangible asset has zero salvage value after it expires or ceases to exist. Hence for intangible asset valuation, the financial ratios may be modified to account for zero salvage value.

For example, in certain embodiments, a risk weighted growth multiple (RWGM) or a modified PE multiple is determined based on the one or more financial ratios. The RWGM or the modified PE multiple is a mathematical indicator that measures the growth potential taking into consideration the inherent risks involved. The financial ratios reflecting current market scenario is modified based on risk factors (e.g., technology or product specific risks) and remaining economic life or score. As will be appreciated by those skilled in the art, in certain embodiments, the remaining, economic life may be less than the remaining legal life. The present value of all future earnings is then determined at step 28 by applying the RWGM or the modified PE multiple to the current earning.

As noted above, the financial ratios may be modified based on one or more parameters associated with a market or the intangible asset. For example, with respect to a product based on patented technology, the one or more parameters may include parameters associated with technology, parameters associated with product, parameters associated with patent or legal parameters, and parameters associated with market. The “TABLE 1” below lists a number of parameters belonging to above listed category of parameters.

TABLE 1

| Category | Parameters |
|---|---|
| Technology | Degree of contribution to the claimed product |
| | Technical superiority over substitutes |
| | Ease of detection of infringement, Ease of duplication/ |
| | design around |
| | Convoyed sales |
| Product | Number of substitutes |
| | Investment required for production |
| | Importance of the product in the buyer's portfolio |
| Patent/ | Buyer's propensity to litigate |
| Legal | Industry's propensity to litigate |
| | Commercial relationship between the licensor and licensee |
| | Statistical assessment of the patent |
| | Remaining Economic Life |
| Market | Target Customer Segment/Industry |
| | Fragmentation of the industry |
| | Revenue prospects from out licensing |
| | Demand for the product related to the patented technology |
| | Application areas of the patented technology |

Further, in certain embodiments, determining the value of the intangible asset at step 30 includes the step of estimating or determining a present royalty rate and/or a past royalty rate via a royalty assessment model. The present royalty rate and/or the past royalty rate is the share of operating profits payable to the seller and different for future and/or past infringements respectively. The royalty assessment model estimates or determines the present and/or the past royalty rates based on a number of parameters. These parameters may include, but are not limited to, parameters accounting for contribution of intangible asset to the claimed product or service and parameters accounting for commercial or market factors. Parameters accounting for technical factors, out licensing opportunities, economic life, and requirement of future investment may also be considered while estimating or determining royalty rate for future infringement. The value of the intangible asset is then determined at step 30 by applying the present royalty rate to the present value of all future earnings and/or by applying the past royalty rate to the past earnings.

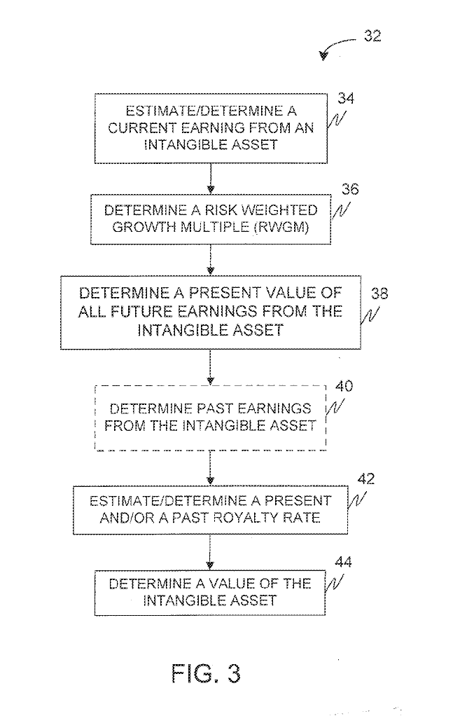

By means of further example, the intangible asset valuation technique depicted in FIG. 2 may further be elaborated as shown in FIG. 3. As illustrated in the flowchart set forth in FIG. 3, the control logic 32 includes the steps of estimating or determining a current earning from an intangible asset at step 34, determining a risk weighted growth multiple (RWGM) for the intangible asset based on one or more financial ratios at step 36, and determining a present value of all future earnings from the intangible asset based on the current earning and the risk weighted growth multiple at step 38. Additionally, as noted above, in certain embodiments, the control logic 32 includes the steps of determining past earnings from the intangible asset at step 40. The control logic 32 further includes the steps of estimating or determining a present royalty rate and/or a past royalty rate via a royalty assessment model at step 42, and determining a value of the intangible asset based on the present value of all future earnings and the present royalty rate and/or the past earnings and the past royalty rate at step 44.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

As will be appreciated by those skilled in the art, the technique, described in the various embodiments discussed above, is efficient and quicker than the traditional income approach. Additionally, the technique is objective, quantified, and parametric rather than subjective. Further, the technique accounts for statistical ranking of the intangible asset vis-à-vis other similar intangible asset. Moreover, the technique allows for separate consideration of past and future infringements through separate past and future royalty rates.

In the traditional income approach, estimate of growth and risks associated with an intangible asset (e.g., patent/technology) is subjective and therefore differs substantially from one analyst to another. However, the techniques, described in the various embodiments discussed above, employ financial ratios corresponding to a company or an industry relevant to the intangible asset, thereby reducing the subjectivity. As will be appreciated by those skilled in the art, RWGM or modified PE multiple is derived from readily available financial data and ratios such as PE ratio and PB ratio. As these financial ratios represent the opinion of multiple real investors, the RWGM or the modified PE multiple is context specific, reflects growth prospects and market risk as perceived by real investors, and can be easily modified to reflect specific risks associated with intangible asset. In other words, the RWGM or the PE multiple provides a relatively more accurate estimation of the growth rate and the risk associated with the intangible asset.

While only certain features of the invention have been illustrated and described herein, many modifications and changes will occur to those skilled in the art. It is, therefore, to be understood that the appended claims are intended to cover all such modifications and changes as fail within the true spirit of the invention.

1. A computer implemented method for valuation of intangible assets, the method comprising:
determining a present value of all future earnings from an intangible asset based on a current earning and one or more financial ratios; and
determining a value of the intangible asset based on the present value of all future earnings.

2. The method of claim 1, wherein the current earning comprises a projected or an actual earning in a year of analysis.

3. The method of claim 1, wherein the one or more financial ratios comprise a price-earnings (PE) ratio, a price-book value (PB) ratio, an operating profit margin, and a net profit margin.

4. The method of claim 1, wherein the one or more financial ratios correspond to a company or an industry relevant to the intangible asset.

5. The method of claim 1, wherein determining the present value of all future earnings comprises modifying the one or more financial ratios to reflect growth and risks associated with the intangible asset.

6. The method of claim 1, wherein determining the present value of all future earnings comprises modifying the one or more financial ratios to reflect a finite life of the intangible asset.

7. The method of claim 1, wherein determining the present value of all future earnings comprises modifying the one or more financial ratios based on one or more parameters associated with a market or the intangible asset.

8. The method of claim 1, wherein determining the present value of all future earnings comprises determining a risk weighted growth multiple (RWGM) based on the one or more financial ratios.

9. The method of claim 8, wherein determining the present value of all future earnings comprises applying the risk weighted growth multiple to the current earning.

10. The method of claim 1, wherein determining the value of the intangible asset comprises estimating or determining a present royalty rate via a royalty assessment model.

11. The method of claim 10, wherein determining the value of the intangible asset comprises applying the present royalty rate to the present value of all future earnings.

12. The method of claim 1, further comprising determining past earnings from the intangible asset and determining the value of the intangible asset based on the past earnings.

13. The method of claim 12, wherein determining the value of the intangible asset comprises estimating or determining a past royalty rate via a royalty assessment model and applying the past royalty rate to the past earnings.

14. A computer implemented method for valuation of intangible assets, the method comprising:
estimating or determining a current earning from an intangible asset;
determining a risk weighted growth multiple (RWGM) for the intangible asset based on one or more financial ratios;
determining a present value of all future earnings from the intangible asset based on the current earning and the risk weighted growth multiple;
estimating or determining a present royalty rate via a royalty assessment model; and
determining a value of the intangible asset based on the present value of all future earnings and the present royalty rate.

15. A tangible, machine readable media, comprising:
routines for determining a present value of all future earnings from an intangible asset based on a current earning and one or more financial ratios; and
routines for determining a value of the intangible asset based on the present value of all future earnings.

16. The machine readable media of claim 15, wherein routines for determining the present value of all future earnings comprises routines for determining a risk weighted growth multiple (RWGM) based on the one or more financial ratios and routines for applying the risk weighted growth multiple to the current earning.

17. The machine readable media of claim 15, wherein routines for determining the value of the intangible asset comprises routines for estimating or determining a present royalty rate via a royalty assessment model and routines for applying the present royalty rate to the present value of all future earnings.

18. A system for valuation of intangible assets, the system comprising:
a processor configured to determine a present value of all future earnings from an intangible asset based on a current earning and one or more financial ratios and to determine a value of the intangible asset based on the present value of all future earnings.

19. The system of claim 18, wherein the processor is configured to determine the present value of all future earnings by determining a risk weighted growth multiple (RWGM) based on the one or more financial ratios and by applying the risk weighted growth multiple to the current earning.

20. The system of claim 18, wherein the processor is configured to determine the value of the intangible asset by estimating or determining a present royalty rate via a royalty assessment model and by applying the present royalty rate to the present value of all future earnings.
